(19) United States
(12) Patent Application Publication
(10) Pub. No.: US 2023/0014067 A1
(43) Pub. Date: Jan. 19, 2023

(54) METHOD FOR NUMERICAL SIMULATION BY MACHINE LEARNING

(71) Applicant: EXTRALITY, Paris (FR)

(72) Inventors: Pierre YSER, PARIS (FR); Hainiandry RASAMIMANANA, PARIS (FR)

(21) Appl. No.: 17/787,314

(22) PCT Filed: Dec. 16, 2020
(86) PCT No.: PCT/FR2020/052469

§ 371 Date: Jun. 18, 2022

(30) Foreign Application Priority Data
Dec. 19, 2019 (FR) FR1914967

(51) Int. Cl. G06F 30/28; G06F 30/27

(52) U.S. Cl. CPC G06F 30/28; G06F 30/27; G06F 2111/10

(57) ABSTRACT

A computer-implemented numerical simulation method for studying a physical system governed by at least one differential equation such as a fluid in motion. The simulation is launched, making it possible to define a simulation domain. In the computation step, a machine learning algorithm is implemented to predict a global solution to the equation in the simulation domain. The computation step includes n consecutive sequences, each sequence includes cutting a piece in the simulation domain followed by predicting a local solution in the piece on the basis of local boundary conditions, n being an integer strictly greater than 1. The prediction step being carried out by a machine learning model, as input, global boundary conditions on the simulation domain.

### TECHNICAL FIELD

The present invention belongs to the field of numerical simulation, in particular the numerical simulation of physical phenomena, and more particularly concerns a method for numerical simulation, and more specifically a method for numerical computation, based on machine learning.

The invention also relates to the field of artificial neural networks implementing deep learning techniques.

### BACKGROUND OF THE INVENTION

Numerical simulation consists in running a computer program on a computer in order to simulate a real phenomenon on the basis of a theoretical model. This is in fact an essential tool for studying complex physical phenomena such as the flow of fluids. More generally, numerical simulation makes it possible to study different systems in the natural sciences (physics, chemistry, biology, etc.), as well as in the social sciences (economics, sociology, etc.).

In general, numerical simulation is used to obtain an approximation of the solution to an equation when the analytical solution is complex or even inextricable. For example, numerical simulation is almost indispensable in the case of nonlinear partial differential equations that govern certain physical principles and phenomenological behaviors, including a wide range of transport and propagation phenomena.

Thus, numerical simulation uses numerical means implementing algorithms (computation codes), which are sometimes sophisticated, in order to solve this type of equation. The development of numerical simulation is therefore very closely tied to advances in the field of computer science, as evidenced by the recent applications of artificial intelligence and big data in certain numerical simulation methods (several patent documents).

Among the equations that require numerical simulation in order to be solved are Navier-Stokes equations. The set of techniques for numerical resolution of these equations, in the context of fluid simulations, constitute the field of computational fluid dynamics, commonly referred to by the acronym CFD.

Classic CFD methods are time-consuming and require significant computational resources. Typically, a routine industrial computation may take between one-half day and three months, bearing in mind that a team of engineers in the aeronautics or automobile industry or an associated industry must generally carry out, on average, tens of thousands of simulations per year for design, validation and certification phases accompanying the development of a product. Therefore, the current CFD methods are highly disadvantageous in terms of time, especially when they are accompanied by pre-processing phases, which are technically complex and therefore costly.

In spite of the above-mentioned disadvantages, CFD methods currently remain the most reliable and widespread numerical simulation methods in the scientific and industrial communities. They make it possible to achieve very high precision, but require more time and computation resources. In addition, the control of CFD simulations is often complex, frequently leading to instability. In other words, minor variations in initial conditions and/or parameters may lead to very different or even entirely different solutions. There is an approach, as an alternative to CFD methods, consisting in developing surrogate models, which are, for example, linearized versions of CFD equations adapted to specific cases of application. This approach may be much faster than the CFD method due to an independent construction of the system studied and modeling by analytical functions that are easy to evaluate, but which are that much less precise, or even unreliable, especially when the linearization assumptions are no longer respected.

All of these known methods, CFD and surrogate models, are based on physical modeling by mathematical formalism, and therefore on solving equations. As a consequence, they use matrix inversions of which the size and complexity depend upon the desired volume and precision of the computation.

Nevertheless, statistical approaches may be used to model physical phenomena and may be based on predictive models resulting from machine learning techniques. These methods include methods based on statistical learning, such as kernel methods, evolutionary optimization methods for constructing surrogate models, simulations by learning implemented by artificial neural networks, etc.

The advent of machine learning in the field of numerical simulations, in particular CFD, made it possible to reduce the computation time. For example, machine learning can be used to improve the rendering of computer graphics and thus enhance the realism thereof, or to predict fluid motion. In the latter case, the objective of the learning model is to predict the future state of the fluid on the basis of its state at an earlier time. This is made possible by means of training phases with a large number of CFD solutions. However, these methods are carried out on the entire simulation domain in order to obtain a global solution and are therefore constrained by the size of the domain.

There is no method for numerical simulation by machine learning known to the applicant that makes it possible to predict the solution locally and to subsequently reconstruct the global solution over the entire simulation domain.

### OBJECT AND SUMMARY OF THE INVENTION

The present invention aims to overcome the disadvantages of the prior art described above, considering, on the one hand, the needs for classic numerical simulation methods, such as CFD methods, in terms of computation time and resources, and, on the other hand, the limited precision of surrogate models. More specifically, an objective of the invention is to propose a method for numerical simulation by machine learning that involves a piecewise prediction on the simulation domain so as to be faster than the CFD methods and more precise than the surrogate models.

To this end, the present invention relates to a computer-implemented numerical simulation method for studying a physical system governed by at least one differential equation such as a fluid in motion, including a step of launching the simulation, making it possible to define a simulation domain, and a step of computation, implementing a machine learning algorithm for predicting a global solution to the equation in the simulation domain. This method is notable in that the computation step includes n consecutive sequences each including a step of cutting a piece in the simulation domain followed by a step of predicting a local solution in the piece on the basis of local boundary conditions, n being an integer strictly greater than 1, the n cut pieces covering the entire simulation domain, wherein the prediction step is carried out by a machine learning model taking, as input, global boundary conditions on the simulation domain, and wherein the global solution is reconstructed on the basis of the local solutions.

Advantageously, the machine learning model is a physics-informed local deep learning network trained by means of existing numerical simulations.

Thus, the method according to the invention does not generate target solutions according to the problem but uses target solutions extracted from previously generated “classic” simulations.

More specifically, the local boundary conditions are extracted by the machine learning model from existing numerical simulations cut into samples, each sample being associated with local boundary conditions so as to form learning data.

Therefore, the method makes it possible to extract local solutions from existing global solutions in order to constitute the learning data of the model.

Advantageously, each piece cut in the simulation domain overlaps with at least one other piece so as to allow the local boundary conditions to be updated.

Thus, with each local prediction on a piece, the boundary conditions on one or more neighboring pieces are updated sequentially.

According to an embodiment of the invention, the steps of cutting the simulation domain are carried out from left to right and from top to bottom of said domain.

According to the invention, the computation step is iterative, the iteration being conditioned by a convergence of the global solution of the numerical simulation.

Advantageously, the equation governing the simulated physical system is used to define a loss function.

For example, the differential equation of the physical system is a partial differential equation.

According to an embodiment of the invention, the physical system is a fluid in motion governed by the Navier-Stokes equations.

The invention also relates to a computer program comprising a set of program code instructions that, when executed by a processor, configure said processor to implement a numerical simulation method as presented.

The fundamental concepts of the invention having been described above in their most basic form, additional details and features will emerge more clearly on reading the description that follows and in view of the appended drawings, presenting, by way of a non-limiting example, an embodiment of a method for numerical simulation by machine learning in accordance with the principles of the invention.

### BRIEF DESCRIPTION OF THE FIGURES

The figures are provided purely as an illustration for comprehension of the invention and do not limit the scope thereof. In all of the figures, identical or equivalent elements are designated by the same reference sign.

It is thus illustrated, in:

FIG. 1: a numerical simulation obtained by a CFD method;

FIG. 2: a block diagram of a machine learning model according to the invention for predicting a global solution on the basis of global boundary conditions;

FIG. 3: a block diagram of the extraction of samples of a CFD solution and the association of local boundary conditions;

FIG. 4: a simplified diagram of the piecewise simulation method according to the invention;

FIG. 5: a schematic representation of a cutting step according to an embodiment of the invention;

FIG. 6: a representation of a cutting step, on a simulation domain, according to another embodiment of the invention;

FIG. 7: the main steps of a numerical simulation method according to an embodiment of the invention;

FIG. 8: simulation results of an air flow around an aircraft airfoil obtained by the method of the invention; and

FIG. 9: simulation results of an air flow around a vehicle.

### DETAILED DESCRIPTION OF EMBODIMENTS

In the embodiment described below, reference is made to a method for numerical simulation by machine learning intended primarily for studying the motion of fluids, for example motion illustrated by the flow of air around an airfoil.

This non-limiting example is provided for better comprehension of the invention and does not rule out the use of the method to simulate other physical or economic phenomena or other phenomena governed by differential equations.

It should first be noted that the invention is based on the fundamental property according to which any differential equation is verified locally, and can therefore be solved with the boundary conditions, in which case it is a question of multi-scale modeling.

In the description below, we will be concerned with context of fluid mechanics, for the simulation of fluid flows around obstacles such as aircraft airfoils. The acronym CFD is used to designate what pertains to computational fluid mechanics and related methods. Fluids in motion obey the known Navier-Stokes equations and, according to the physical variable considered, verify laws of conservation and/or transport (advection, diffusion). These are nonlinear partial differential equations (abbreviated PDE).

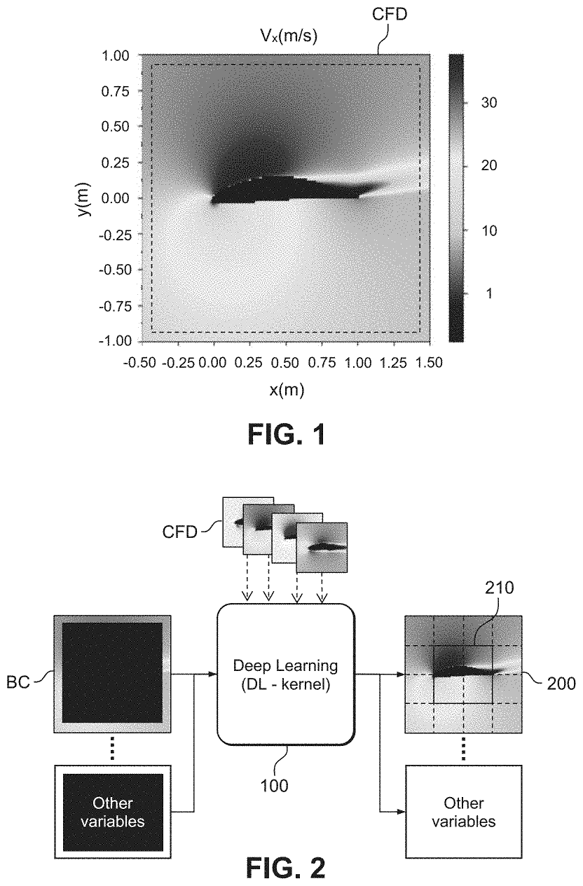

FIG. 1 shows a CFD solution of the velocity field, and more specifically of component Vₓ of the velocity vector, of the air flow flowing around a zero-incidence profile at a given time. It is observed that this flow is accelerated on the suction side in a low-pressure area that, with a high-pressure area at the pressure side, makes lift possible. However, this is not the object of the invention. Such a CFD solution can be approximated with a high precision owing to machine learning technology. The numerical simulation method according to the invention is implemented by a machine learning model. This model is, for example, a deep learning artificial neural network.

In reference to FIG. 2, the method of the present invention is based on a neural network 100 implementing a machine learning technique, preferably a deep learning technique, capable of locally learning the solution functions of the flow equation in order to construct a global solution 200 on the basis of local predictions, as explained below. The network 100 is a physics-informed local deep learning network, making it possible to learn and approximate in a piecewise manner the solutions of Navier-Stokes equations without any matrix inversion, unlike the classic numerical simulation methods. In addition, convergence criteria are no longer required.

The network 100 is supplied with CFD solutions, such as the solution of FIG. 1, during training phases as shown in FIG. 2. In the context of development of the present invention, this network has been trained by a set of big data representing tens of thousands of CFD solutions concerning more than 1500 different airfoils, for the application of said network in the field of aerodynamics in order to simulate air flows around airfoils having different geometries.

In addition, the physics equations are used to force the neural network 100 to improve its prediction as well as the efficiency of its learning, as is standard practice in the field.

According to an advantageous aspect of the invention, the network 100 takes, as input, boundary conditions BC extracted from CFD solutions, and other input variables (initial conditions, geometric parameters, and other pre-processing variables), and makes it possible to obtain, as output, the global solution 200, restored from predicted local solutions, and other output variables including the other physical variables of the equation.

For example, the boundary conditions include a Dirichlet boundary condition, a Neumann boundary condition, or a combination of the two.

In fact, the network 100 carries out a construction of the global solution 200 based on local solutions 210 that have been “patched together”, each of the local solutions resulting from a prediction of the behavior of the fluid within the boundary conditions of a sample extracted from the network training CFD solutions.

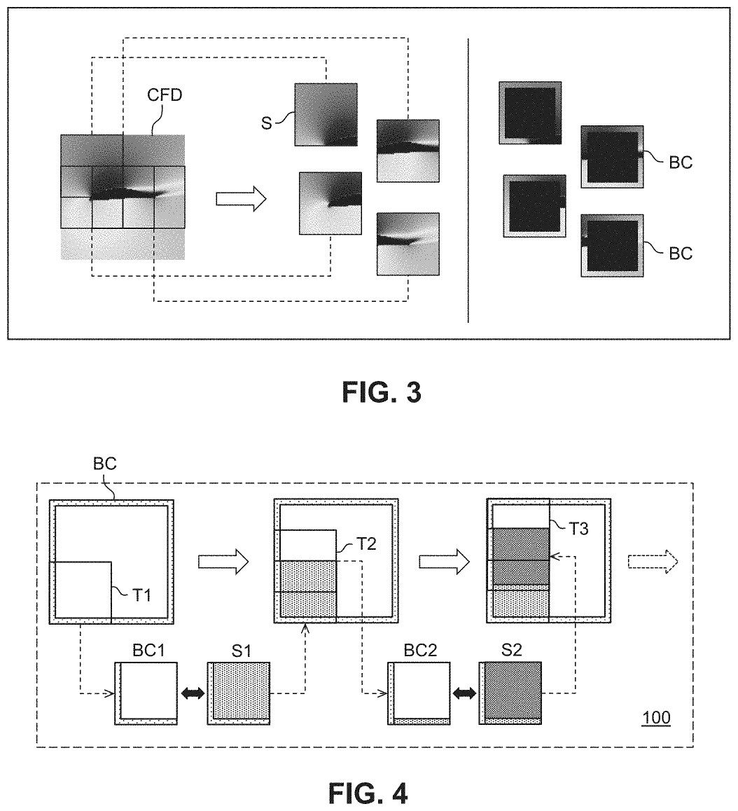

FIG. 3 illustrates the extraction of the local boundary conditions BC of a CFD solution. In fact, the CFD solution is cut into pieces each corresponding to a sample S, then local boundary conditions BC are extracted from each sample S, and will serve as learning data in the network 100 during the prediction of local solutions 210. In other words, pairs (sample S—local boundary conditions BC of said sample) will serve as a basis for the classification carried out by the network 100.

Thus, from a single CFD solution, the network 100 can extract a predetermined number of samples S in order to create local target functions corresponding to the local solutions 210. This allows the network 100 to base its learning on basic geometric patterns, such as profile portions having a simple curvature, in order to predict the behavior of the fluid around a complete shape in other simulations.

FIG. 4 provides a diagram of the operation of the network 100, according to a simplified example, for generating a global solution from initial conditions BC as input (see FIG. 2). The method implemented by the network 100 corresponds to a piecewise approach in which a first piece T1 is delimited from the border of the simulation domain, the piece therefore including a portion of the input boundary conditions BC, and associated with a learning pair BC1-S1 representing local boundary conditions BC1 and an associated local solution S1. The local solution S1 is therefore injected by inference into the piece T1 of the simulation domain. A second piece T2 overlapping the first piece T1 is then delimited in the simulation domain, the overlap making it possible to update the boundary conditions, and associated with a pair BC2-S2. The operation is continued until the simulation domain is entirely covered. Then, this piecewise construction of the global solution is iterated until convergence.

Thus, the physics-informed local deep learning network 100 carries out a piecewise numerical simulation according to a precise cutting of the simulation domain.

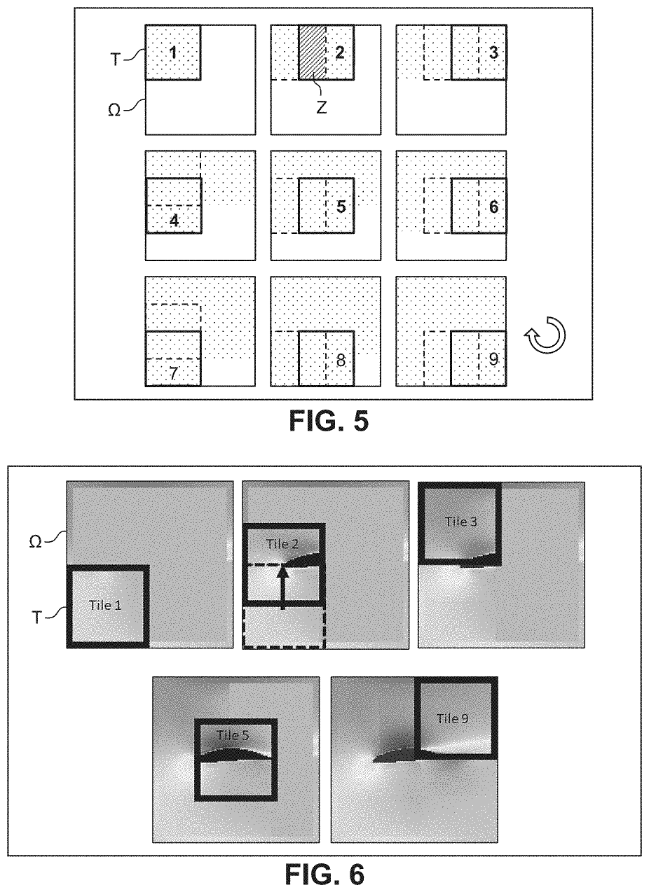

FIG. 5 provides a diagram of an example of a piecewise simulation on a simulation domain Ω, making it possible, via a precise cutting of the domain Ω into basic pieces T and a prediction of the local solution on each of the pieces as the cutting is performed, to obtain the prediction of the global solution on the entire domain Ω. In fact, according to the simplified example of the figure, a first piece at the top left of the domain Ω is initially delimited, the local solution is estimated there by means of the network 100 using deep learning, the fill points indicating the local solution on each piece concerned. The second piece is delimited in the domain Ω and must overlap with the preceding piece over a zone Z in order to update the boundary conditions as noted above. In the example of FIG. 5, the cutting of the domain into pieces is carried out from left to right and from top to bottom, the rows being scanned first, mirroring the relative movement of the air flow around the profile. The precision and speed of the computation depend upon the number of pieces, and therefore the size of the pieces for a given domain. The circular arrow at the bottom right of FIG. 5 indicates that the piecewise simulation operation is iterative.

FIG. 6 provides another example of the piecewise simulation method according to a different cutting of the domain, carried out from bottom to top and from left to right, with the columns scanned first.

The cutting of the domain in the context of the piecewise implementation of the simulation can be performed in different ways provided that the overlap between pieces is respected, and more specifically the overlap between each piece and a piece cut before, which is necessary for updating the boundary conditions during cutting. For example, the cutting can be linear from left to right, from top to bottom, or the reverse, diagonal or in a spiral converging at the center of the simulation domain, or even random. Other ways of segmenting the domain may be used provided that the overlap is respected.

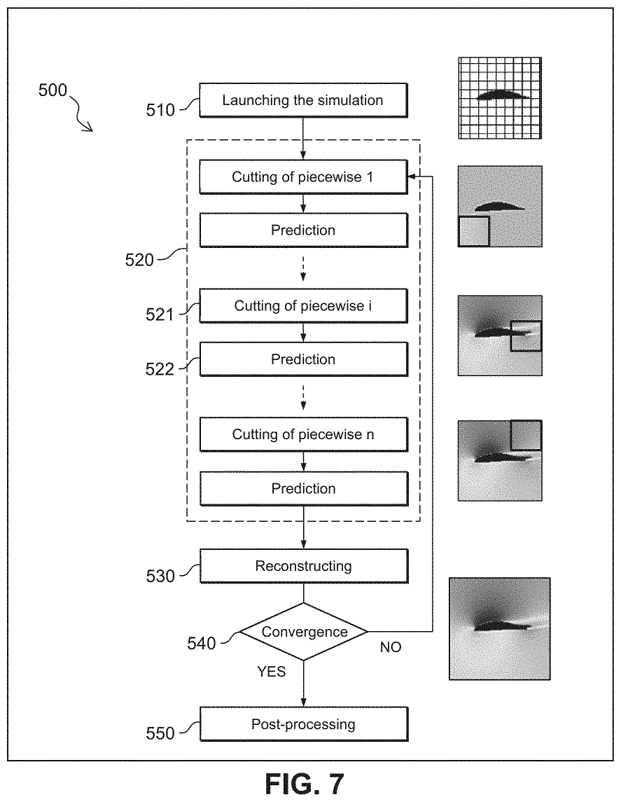

FIG. 7 shows the main steps of a method 500 for numerical simulation by machine learning, according to an embodiment of the invention, the method comprising:
an initial step 510 of launching the simulation;
an iterative step of piecewise computation 520, comprising sub-steps of cutting 521 and prediction 522;
an iterative step of reconstructing 530 the global solution;
a convergence test 540; and
a post-processing step 550.

The step 510 of launching the simulation comprises, for example, the pre-processing, the adjustment of boundary conditions and initial conditions (initial field and boundary conditions, for example), the adjustment of physical properties, and time control (adjustment of the time step), according to the nature of the phenomenon studied. The boundary conditions will make it possible to define the input of the neural network 100, which carries out the computation step 520.

The local piecewise computation step 520, shown diagrammatically in FIGS. 4 to 6, includes consecutive cutting—prediction operations consisting in predicting a local solution on each piece cut in the simulation domain. In general, the local piecewise computation step 520 includes steps 521 of cutting the piece i, i being a natural integer between 1 and n inclusive, and n being the number of pieces chosen. Each cutting step 521 is followed by a step 522 of predicting the local solution in the cut piece i.

The global solution (over the entire simulation domain) is then reconstructed in the reconstruction step 530, which may be implicit.

The steps of piecewise computation 520 and reconstruction 530 are reiterated until convergence of the global solution.

The computation constitutes the step requiring the most computation resources and time.

Various techniques make it possible to optimize the use of the computation resources, such as parallel computation.

The post-processing step 550 finally makes it possible to use the results of the numerical simulation via physical and/or statistical analyses and corresponds, for example, to the visualization of different variable fields (velocity, pressure, etc.).

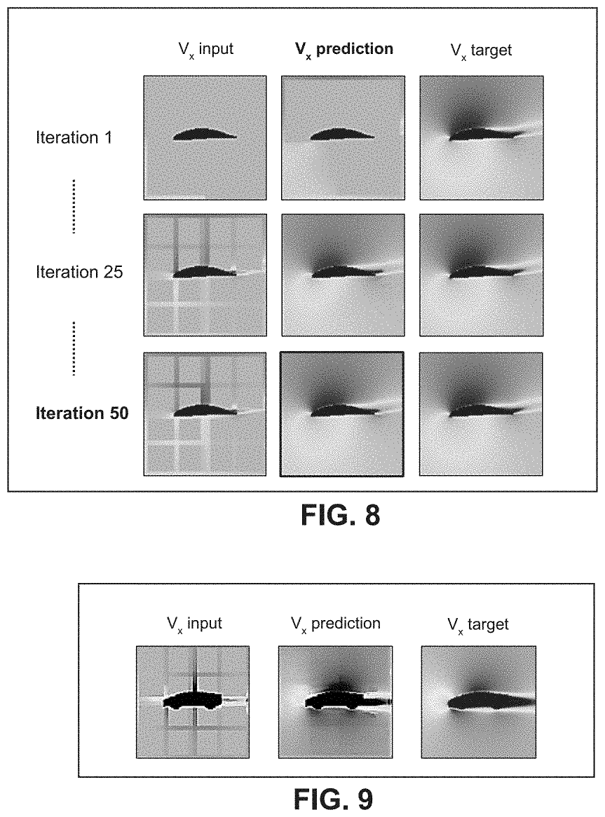

FIG. 8 shows the simulation results of the velocity field of the relative motion of an air flow around a profile, obtained by the machine learning simulation method according to the invention, at different iterations: 1, 25 and 50. Before each iteration, the input velocity boundary conditions, the prediction obtained by the method and the target CFD solution are represented, the latter being the same in all of the iterations. It may be noted that the difference between iteration 25 and iteration 50 is relatively small and that the convergence of the solution is quickly established by virtue of the method of the invention.

The method has also been extrapolated to other geometries of obstacles with satisfactory results. An example of a simulation of the air flow around a motor vehicle is provided in FIG. 9.

To train the network 100, any CFD solution may be used and cut into pieces of different sizes so as to obtain the learning samples, the pieces being used as supervised classifiers.

The physical equations of the theoretical model are used in loss functions in both supervised learning and unsupervised learning, using residuals of said equations in the latter case.

In fact, if it is considered that V is the unknown vector of the equation of the system, a cost function can be constructed as follows:

C=aₘₐₜₕ·M(V_{pred},V_{targ},aₛᵤₚ)+a_{phys}·(H(V_{pred})−aₛᵤₚH(V_{targ}))

wherein the indices targ and pred correspond respectively to the target solution and the solution predicted by the network, aₛᵤₚ is a coefficient between 0 and 1 for activating the supervised learning, aₘₐₜₕ is a coefficient between 0 and 1 for adding a typical machine learning loss (L2 or L3 norm, for example), a_{phys} is a coefficient between 0 and 1 for activating the physical loss (i.e. the residual of the equation of the system), and M is a linear operator making it possible to couple the different machine learning losses.

The numerical simulation method according to the present invention has been found to be thirty times faster than a classic CFD method, with 98% precision compared to the CFD method on 128×128-pixel images.

In view of the description, the machine learning simulation method can be modified and/or adapted slightly without going beyond the scope of the invention. This method has direct, non-limiting applications in technological industries such as the aeronautics, space, automobile, energy, naval and multimedia (video games, special effects, etc.) industries.

1-9. (canceled)

10. A computer-implemented numerical simulation method for predicting a motion of a fluid governed by at least one differential equation, comprising: launching a simulation, making it possible to define a simulation domain, and computation, implementing a machine learning algorithm to predict a global solution to said at least one differential equation in the simulation domain, wherein the computation comprises n consecutive sequences, each sequence comprising cutting a piece in the simulation domain followed by predicting a local solution in the piece on a basis of local boundary conditions, n being an integer strictly greater than 1, n cut pieces covering an entire simulation domain, wherein the predicting step is carried out by a machine learning model taking, as input, global boundary conditions on the simulation domain, and wherein the global solution is reconstructed on a basis of the local solutions.

11. The numerical simulation method of claim 10, wherein the machine learning model is a physics-informed local deep learning network trained by means of existing numerical simulations.

12. The numerical simulation method of claim 10, wherein the local boundary conditions are extracted by the machine learning model from existing numerical simulations cut into samples, each sample being associated with the local boundary conditions so as to form learning data.

13. The numerical simulation method of claim 10, wherein each piece cut in the simulation domain overlaps with at least one other piece so as to allow the local boundary conditions to be updated.

14. The numerical simulation method of claim 10, wherein the simulation domain is cut from left to right and from top to bottom of the simulation domain.

15. The numerical simulation method of claim 10, wherein the computation step is iterative, the iteration being conditioned by a convergence of the global solution.

16. The numerical simulation method of claim 10, wherein said at least one differential equation is used to define a loss function.

17. The numerical simulation method of claim 10, wherein said at least one differential equation is a partial differential equation.

18. A computer program comprising a set of program code instructions executable by a processor to implement the numerical simulation method of claim 10.
